(19) United States
(12) Patent Application Publication
(10) Pub. No.: US 2012/0198926 A1
(43) Pub. Date: Aug. 9, 2012

(54) Measuring Arrangement for Measuring the Application Force of a Disc Brake and a Corresponding Disc Brake

(75) Inventors: Johann BAUMGARTNER, Moosburg (DE); Steffen Geissler, Rodgau (DE); Robert Gruber, Pfaffing (DE)

(73) Assignee: KNORR-BREMSE Systeme fuer Nutzfahrzeuge GmbH, Muenchen (DE)

(21) Appl. No.: 13/421,284

(22) Filed: Mar. 15, 2012

Related U.S. Application Data
(63) Continuation of application No. PCT/EP2010/063485, filed on Sep. 14, 2010.

(30) Foreign Application Priority Data
Sep. 17, 2009 (DE) 10 2009 041 951.9

(51) Int. Cl. G01L 5/28

(52) U.S. Cl. 73/132

(57) ABSTRACT

A measuring arrangement measures the application force of a disc brake. The arrangement includes two disc brake components displaceable relative to each other upon application of the force; an application force sensor having a housing; a measuring object formed by one of the two components and having a metal end face for interacting with the application force sensor in a contact-free manner, and an evaluation unit. The application force sensor is an eddy current sensor for capturing a displacement along the path. The evaluation unit converts the captured displacement into a measurement variable as a measure for the application force. The application force sensor and the measurement object are removably mounted on the respective component.

### CROSS-REFERENCE TO RELATED APPLICATIONS

This application is a continuation of PCT International Application No. PCT/EP2010/063485, filed Sep. 14, 2010, which claims priority under 35 U.S.C. §119 from German Patent Application No. DE 10 2009 041 951.9, filed Sep. 17, 2009, the entire disclosures of which are herein expressly incorporated by reference.

### BACKGROUND AND SUMMARY OF THE INVENTION

The invention relates to a measuring arrangement for measuring the application force of a disc brake. The invention also relates to a corresponding disc brake.

Disc brakes can have different measuring arrangements for measuring an application force, wherein for this purpose, for example, pressure sensors are used in a hydraulic brake. However, a disc brake on a vehicle is subject to relatively extreme operating conditions which can influence in different ways a measurement variable which correlates with the application force of the disc brake.

The object of the present invention is therefore to make available an improved measuring arrangement. A further object is to provide an improved corresponding disc brake.

This and other objects are achieved by a measuring arrangement, and a disc brake incorporating said measuring arrangement, for measuring the application force of a disc brake, comprising: two components of the disc brake which can be moved, in particular displaced, relative to one another along a displacement distance when an application force is applied; at least one application force sensor having a housing; a measuring object, which is one of the two components or can be permanently connected to one of the two components and comprises at least one metallic end face or at least one target object with at least one metallic end face for contactless interaction with the application force sensor; and an evaluation unit. The application force sensor is an eddy current sensor for sensing displacement along the displacement distance with the evaluation unit for converting the sensed displacement into a measurement variable as a measure of the application force. The application force sensor and the measuring object are attachable to the respective component of the two components so as to also be removable.

An advantageous feature of the invention consists in the fact that the application force sensor and the measuring object can be attached to the respective component of the two components in such a way that they can be removed again. This results in easy mounting and a short replacement time when performing maintenance and service, wherein at the same time accuracy of the determined measurement variable is maintained. The range of application is made larger and includes disc brakes of any design, even those with self-energization.

Accordingly, a measuring arrangement for measuring the application force of a disc brake preferably has the following: two components of the disc brake which can be moved, in particular displaced, relative to one another along a displacement distance when an application force is applied, at least one application force sensor having a housing; a measuring object which is one of the two components or can be permanently connected to one of the two components, and comprises at least one metallic end face or at least one target object with at least one metallic end face for contactless interaction with the application force sensor; and an evaluation unit, wherein the application force sensor is an eddy current sensor for sensing displacement along the displacement distance with the evaluation unit for converting the sensed displacement into a measurement variable as a measure of the application force, and wherein the application force sensor and the measuring object can be attached to the respective component of the two components in such a way that they can be removed again.

The application force sensor and the measuring object can be attached to the respective component of the two components in a centered fashion and/or in a positively locking fashion in such a way that they can be removed again. This provides the advantage that the mounting time is shortened, with orientation times being reduced to a minimum.

The application force sensor can be permanently connected to the other component of the two components and is arranged at a distance from the end face along the displacement distance, wherein one of the two components is a caliper back of a brake caliper of the disc brake, and the other of the two components is a caliper head of the brake caliper of the disc brake.

A pickup device having a coil and a booster device are arranged in the housing of the application force sensor. This arrangement is advantageous since, in this way, the detected measurement variable signal can be boosted over the shortest possible displacement distance without interference influences from the outside due to electromagnetic fields. In order to increase the immunity to interference additionally with respect to moisture and dust, the housing can be hermetically sealed. In one embodiment, the housing is manufactured, for example, from a plastic such as, for example, glass-fiber-reinforced polyamide.

The application force sensor is oriented with the coil of the pickup device on a pickup longitudinal axis at a right angle to the end face. This may, for example, be carried out in an easy way by means of a centering device which forms a positively locking engagement by way of faces, edges, centering pins, centering bolts or the like.

The application force sensor has a measuring range which is larger, by an amount equal to installation tolerances which occur and thermally induced changes of length, than the maximum relative displacement of the two components with respect to one another, which is brought about by the application force.

As a result, influence due to interference variables such as changes in length and installation tolerances are largely reduced.

An end face of the application force sensor can be arranged at a distance from the end face of between 0 mm and 10 mm, preferably between 0.5 mm and 6.5 mm. Eddy current sensors are available which also supply a highly accurate signal over a very short distance.

For adaptation to the surroundings, the application force sensor can be designed to output a sensor signal which can be calibrated to the material of the measuring object, of the target object, the material of the surroundings of the measuring object and/or of the target object and/or the geometry of the measuring object and/or of the target object. In this context, surface coatings of the end faces are also taken into account. The material of the housing of the application force sensor can also be included in the calibration. For this purpose, the evaluation device has, for example, a memory device in which corresponding values are stored in table form, on the basis of which values calibration is made easily possible. This storage device can also include values which can be used to output a temperature-compensated sensor signal and/or for zero point alignment of a sensor signal which is to be output.

The zero point corresponds here to the state of the inactivated brake, which serves as a reference for every braking operation. This zero point can be slightly displaced during operation (due to shocks, thermal expansion etc.) and can be displaced to a relatively large degree during maintenance and servicing (for example change of pads). The absolute value of the zero point is not significant owing to linearization of the sensor signal. The application force sensor can therefore also be designed to output a linearized sensor signal by storing the associated values in the evaluation unit. The linearization of the sensor signal can be implemented with respect to a change in position of the measuring object, target object and/or the application force.

In one embodiment, the pickup device, the booster device and the evaluation unit can be arranged in the housing, which results in a compact design.

In an alternative embodiment, the pickup device can be arranged in the housing. It is then possible only for the coil to be present in the housing, which is then considerably reduced in size. In this context, further switching units of the pickup device, the booster device and the evaluation unit can be arranged separately therefrom. This may be integrated, for example, into a wear sensor unit of the brake or into a control unit. As a result, simplified routing of cables can be obtained, with a combination means which reduces expenditure on installation.

In another alternative, the pickup device and the booster device can be arranged in the housing, wherein the evaluation unit can be arranged in a wear sensor unit of the disc brake. In this context, the software of the evaluation unit can be a component of the software of the wear sensor unit, which entails savings in terms of space and components.

The application force sensor can therefore be provided with at least one connecting line and/or output line, which can be connected permanently, and/or at least one connecting line and/or output line, which can be connected via plug-type connector devices. The combination of cables which therefore result with the wear sensor unit or other units of the brake can be led on as a common cable to an EBS control unit.

A combination of cables of the sensor cable and a wear sensor cable is also possible, and in turn reduces expenditure on installation and installation space. The sensor cable can, of course, also be connected directly to a brake control unit.

The housing can easily be attached directly and/or via at least one clip to one of the components and/or to a bottom plate of the disc brake by use of at least one attachment element. The housing can be screwed for the purpose of rapid mounting and dismounting.

The measuring object can be embodied as a pad-mounting bracket, which can be permanently connected to one of the two components of the disc brake and which has the at least one end face or the at least one target object with at least one end face. The target object can be connected to the pad-mounting bracket directly or via a mounting element. In this context, the target object, which is metallic or has a metallic end face, can be screwed on, riveted on, welded on or attached in some other way. It can also be embodied in one piece with the pad-mounting bracket. Of course, the pad-mounting bracket can have more than one end face or more than one target object.

In order to increase the measuring accuracy, the pad-mounting bracket can be attached with a centering device to one of the components. Nevertheless, the pad-mounting bracket can be replaced and removed with simple means. Such a securing process should be at least in the measuring direction of the sensor. The measuring direction is the direction in which displacement of the sensor along its pickup longitudinal axis is detected.

In order to bring about forced guidance, i.e. without lateral offset, sagging, etc., the pad-mounting bracket can be guided in a displaceable fashion with a guide device on the other component in the direction of the displacement distance for the purpose of positive guidance. The pad-mounting bracket is therefore not rigidly fastened to the other component of the disc brake and is freely movable at least in the measuring direction of the sensor with the result that the target object is removed from the coil of the sensor when the application force is built up. This design can be embodied in such a way that the pad-mounting bracket is restricted in its freedom of movement and/or in its degrees of freedom with respect to the brake disc in the radial direction and/or circumferential direction by, for example, correspondingly shaped faces on the brake caliper and/or bottom plate of the disc brake. The fastening of the pad-mounting bracket on the caliper backside can therefore prevent pivoting movements of the target object on the bracket in the transverse direction with respect to the pickup longitudinal axis of the coil of the sensor. As a result, the freedom of movement of the target object can be restricted in the radial and/or circumferential direction with respect to the brake disc.

The fastening of the pad-mounting bracket on the caliper back may be, for example, by way of a bolt connection, a screw connection, a combination thereof or with additional positive engagement.

For the sake of simplified calibration, the pad-mounting bracket and the target object can be manufactured from a material which has properties which are fixed for the calibration.

In order to at least partially compensate for possible pivoting movements of the target object or of the pad-mounting bracket, the end face can have a convex design.

An application force sensor is embodied for an above-described measuring arrangement as described above.

A pad-mounting bracket can be used for an above measuring arrangement as described.

A disc brake has a brake caliper which engages over a brake disc and which has a caliper head and caliper back connected thereto, wherein brake pads which can be pressed against the brake disc on both sides and are secured radially by means of a pad-mounting bracket are mounted in the brake caliper. The disc brake includes the measuring arrangement specified above.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of a first exemplary embodiment of a measuring arrangement according to the invention;

FIG. 2 is a perspective view of a variation of the measuring arrangement according to the invention with a disc brake; and

FIG. 3 is an enlarged perspective view of a second exemplary embodiment of the measuring arrangement according to the invention.

### DETAILED DESCRIPTION OF THE DRAWINGS

Identical components and/or functional units with the same function are characterized with the same reference symbols in the figures.

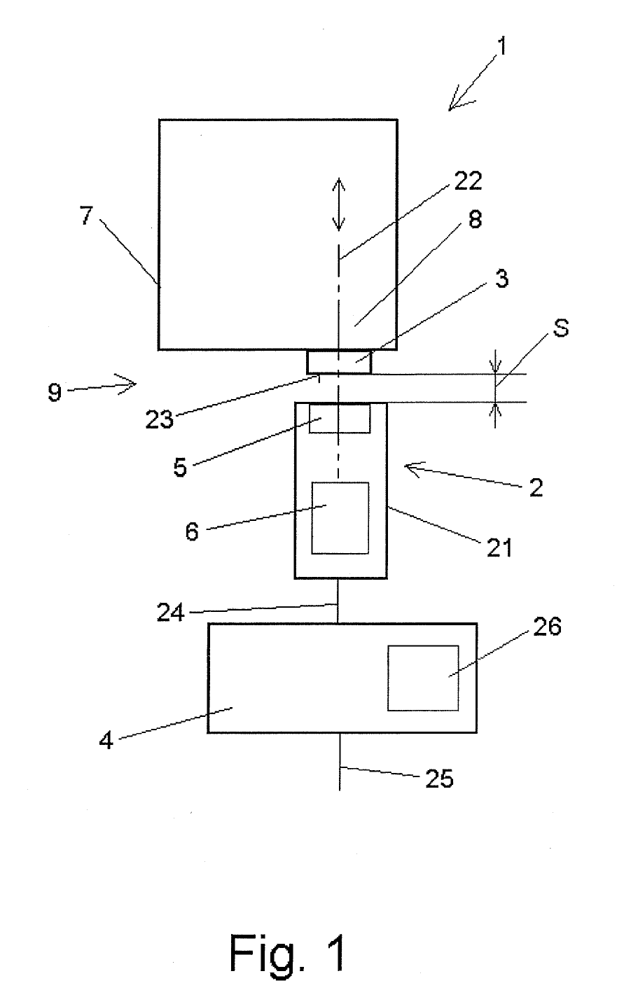

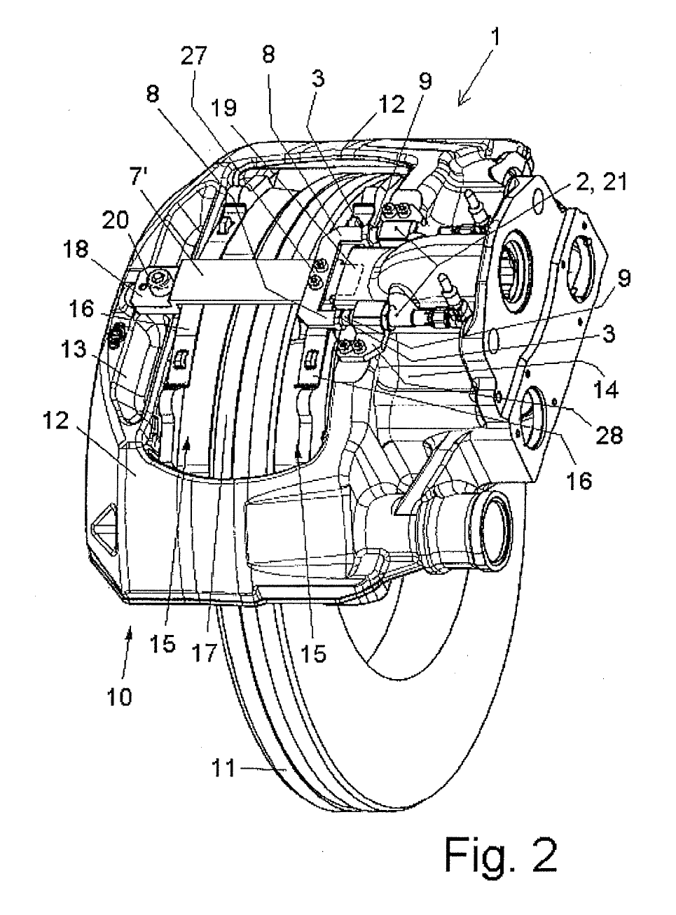

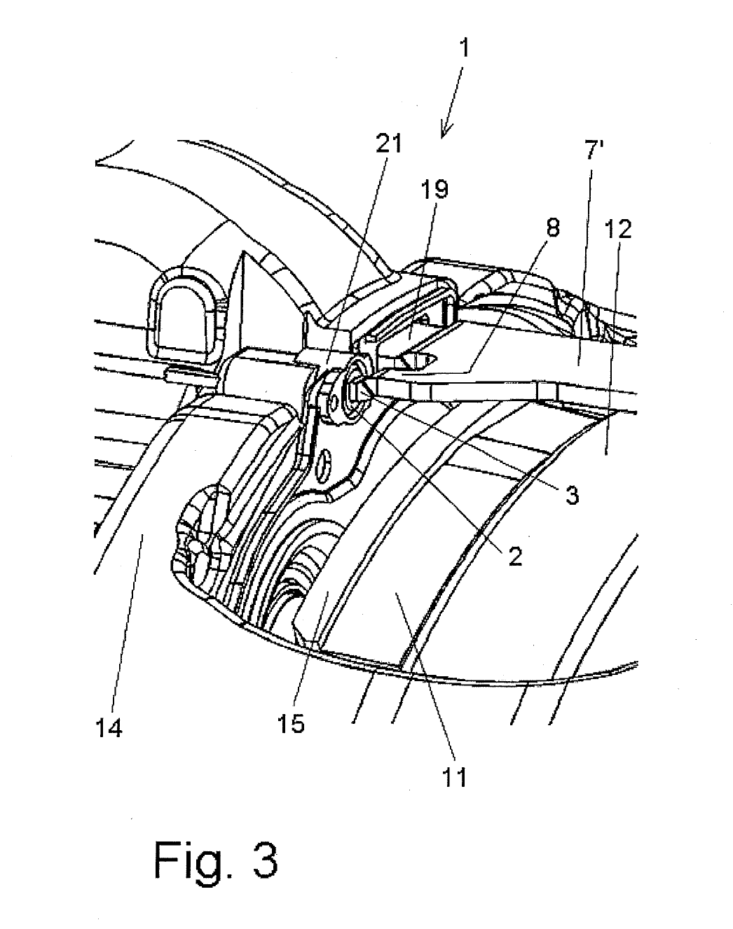

FIG. 1 shows a schematic block diagram of a first exemplary embodiment of a measuring arrangement 1 according to the invention. The measuring arrangement 1 includes an application force sensor 2, an evaluation unit 4 and a measuring object 7 with a target object 3. The measurement variable to be detected is a displacement distance S, which can be varied between the measuring object 7, here between the target object 3 and the application force-sensor 2, by means of a movement (double arrow) of the measuring object 7. The measuring object 7 is a component, or a section of such a component, which can move in the direction of the double arrow through the application of force. In this context and in this example, the measuring object 7 is a section of a brake caliper 10 (see FIGS. 2 and 3) or a component (for example a pad-mounting bracket 7′) which is permanently connected to one side of the brake caliper 10 of a brake, wherein the application force sensor 2 is connected to a side of the brake caliper 10 lying opposite the one side. During a braking process, the brake caliper expands owing to an applied application force, wherein this expansion is detected as a measurement variable displacement distance S. The measurement variable displacement distance S is here a measure of the application force. The measurement preferably takes place in a contactless fashion.

The target object 3 is arranged in a target object section 8 of the measuring object 7. In this example, the target object 3 is a metal plate with specific known properties such as, for example, thermal expansion. The movement of the measuring object 7 is transmitted to the target object 3, with the result that the latter moves along a pickup longitudinal axis 22 to the same degree as the measuring object 7. The target object 3 has an end face 23 which is arranged at a right angle to the pickup longitudinal axis 22 and is arranged lying opposite the application force sensor 2.

The pickup longitudinal axis 22 is, at the same time, a longitudinal axis of the application force sensor 2. The application force sensor 2 includes in this example a housing 21, a pickup device 5 and a booster device 6. The pickup device 5 and the booster device 6 are located in the housing 21. The pickup device 5 has a longitudinal axis which is at the same time the pickup longitudinal axis 22. The housing 21 is hermetically sealed in this design.

The application force sensor 2 is embodied as an eddy current sensor in this example. In this context, the pickup device 5 has a coil which generates an electromagnetic alternating field which penetrates the target object 3 and brings about eddy currents in the material of the metallic target object 3. The intensity of the eddy currents is dependent on the displacement distance S in such a way that in the case of relatively short displacement distance values S the intensity is larger than in the case of relatively large displacement distance values. The alternating electromagnetic field which is generated in the coil is generated by applying electrical energy with a specific magnitude and a specific frequency to the coil from the pickup device 5. Depending on the intensity of the eddy currents generated in the target object 3 and the energy consumed in the process, the pickup device 5 determines an electrical variable as a sensor signal, which variable is proportional to the displacement distance S. This electrical variable, for example current or voltage, is then boosted by the booster device 6 and passed on to the evaluation unit 4 via a connecting line 24. The evaluation unit 4 has here a memory device 26 in which, for example, table values with which the evaluation unit 4 can process the electrical variable supplied by the application force sensor 2 are stored. These may be, for example, a linearization, calibration, temperature compensation, zero point alignment etc. For this purpose, the evaluation unit 4 may have at least one temperature sensor and/or may use a temperature signal, for example that from the application force sensor 2 or some other source (for example, brake control unit, pad wear sensor) for the evaluation.

The application force sensor 2 can either be permanently connected or connected in a pluggable fashion by its connecting line 24 to the evaluation unit 4. It is also possible for the evaluation unit 4 to be arranged completely in the application force sensor 2. However, the evaluation unit 4 can also be accommodated in wear sensor electronics (not shown) of the brake (see FIGS. 2 and 3) or be completely integrated therein, for example as a component of a software package. Another arrangement may take the form that the application force sensor 2 is composed only of the housing 21 and the coil of the pickup device 5, with all the other circuits and switching units being arranged in the evaluation unit 4 (separately or integrated in some other way as described above). The sensor signal which is made available and processed by the evaluation unit 4 is output as a measured value of the application force via an output line 25 and is passed on to further processing means, for example to an EBS system.

Depending on the arrangement described above, the connecting line 24 and/or the output line 25 can be connected directly to a brake system, can be connected to a wear sensor system (permanently or via plug-type connections), and can be led on from there in a common cable to, for example, an EBS, and/or can be combined with a cable of a wear sensor.

The end face 23 of the target object 3 and the assigned end face of the pickup device 5 of the application force sensor 2 are arranged, for example, at a distance between 0 and 10 mm, preferably 0.5 and 6.5 mm.

The measuring range of the application force sensor 2 is made larger, by an amount equal to the installation tolerances which occur and thermally induced changes in length, than is brought about by a maximum displacement which is caused by the application force of the brake.

The calibration properties of the evaluation unit 4 are configured in such a way that the application force sensor 2 and/or its generated sensor signal is calibrated to the material of the target object 3. Calibration of the target object 3 when the latter is coated, for example with paint or other layers, is also possible, as is calibration to the surroundings thereof, for example the geometry of the measuring object 7 or of the target object section 8.

In the case of zero point alignment, the zero point corresponds here to the state of the inactivated brake, which serves as a reference for every braking operation. This zero point can, to a small degree, be displaced during operation (by shocks, thermal expansion etc.) and to a larger extent during servicing of the brakes (for example changing of the pads). The absolute value of the zero point is not significant owing to the linearization of the sensor signal by the evaluation unit 4.

The sensor signal can be linearized with respect to the change in position of the target object 3 and/or to the application force of the brake by way of the evaluation unit 4.

The housing 21 of the application force sensor 2 is manufactured from a resistant material, for example plastic of a glass-fiber-reinforced polyamide type. Examples of attachment to a brake are shown in FIGS. 2 and 3.

FIG. 2 illustrates a perspective view of a variation of the measuring arrangement 1 according to the invention with a disc brake.

The disc brake can be operated pneumatically, hydraulically or electrically. It has a brake caliper 10 which engages over a brake disc 11. On both sides of the brake disc 11, brake pads 15 are arranged, which brake pads 15 can be pressed against the brake disc 11 by way of an application device in order to bring about braking.

The brake caliper 10 is composed of a caliper back 13 and a caliper head 14 which are connected to one another by two tie bars 12. The tie bars 12 run in the axial direction of the brake disc 11 and bound a mounting opening 17 formed in the brake caliper 10 in the circumferential direction of the brake disc 11.

The brake pads 15 are held under prestress in the brake caliper 10, for which purpose each brake pad 15 has a pad-mounting spring 16 (FIG. 2) on which a pad-mounting bracket 7′ is mounted. The pad-mounting bracket 7′ is permanently connected at one end, with an attachment section 18, to the caliper back 13 by use of an attachment element 20, for example a screw, while its other end is mounted in an axially displaceable fashion in a receptacle pocket 19 of the caliper head 14. In this context, the pad-mounting bracket 7′ extends over the mounting opening 17 and runs longitudinally in the axial direction of the brake disc 5.

In its end region, facing the receptacle pocket 19, the pad-mounting bracket 7′ has a U-shaped measuring bracket 27 with two ends running in the axial direction of the brake disc 11. In this second exemplary embodiment, the measuring arrangement 1 includes two measuring points 9, which are arranged parallel to one another and which each have an application force sensor 2 and a target object 3. The target objects 3 are located here at the ends of the measuring bracket 27 which form target object sections 8. Here, in this embodiment, the measuring object 7 is permanently connected to the caliper back 13 in the form of the pad-mounting bracket 7′.

Here also, the application force sensors 2 are permanently connected to the caliper head 14 and are oriented with their pickup longitudinal axes 22 (FIG. 1) parallel to the axis of the brake disc 11. The opening up (expansion) of the brake caliper 10 when an application force is applied causes the caliper back 13 and caliper head 14 to spread apart, i.e. the width of the mounting opening 17 becomes larger. This spreading or opening up of the brake caliper 10 is detected by the application force sensors 2 in that they measure the opening up as displacement distance S (see FIG. 1) between the end faces of the application force sensors 2 and the target objects 3 in the manner specified above. Since two application force sensors 2 are present in this measuring arrangement 1 here, the signals thereof can also be averaged in the evaluation unit 4, as a result of which a higher degree of accuracy in the measurement of the application force can be achieved.

The application force sensors 2 are attached here with their housings 21 on the caliper head 14 by use of a clip 28 and two screws. Such a clip 28 is attached in the longitudinal direction to the housing 21 and runs parallel to the axis of the brake disc 11. In another embodiment, the clip 28 can also surround the housing 21 as a type of sleeve. The housings 21 have faces for the purpose of centering and orientation with the target objects 3, said faces interacting with faces of the caliper head 14. Other fastening and centering possibilities are, of course, possible. This results in simple replacement possibilities when performing maintenance and servicing of the brake.

In this design, the target objects 3 are embodied in one piece with the measuring bracket 27, and the measuring bracket 27 is permanently connected to the pad-mounting bracket 7′ by a screwed connection. Another exemplary embodiment of the measuring arrangement 1 according to the invention is shown in FIG. 3 in an enlarged perspective view.

In the exemplary embodiment of FIG. 3, the measuring object 7 is also embodied as a pad-mounting bracket 7′, wherein here in addition to its end section, which is mounted in the receptacle pocket 19 of the caliper head 14, the pad-mounting bracket 7′ branches into a target object section 8 in the manner of a splayed finger. At the free end of the target object section 8, the target object 3 is embodied in one piece with the target object section 8 and with the pad-mounting bracket 7′ in the manner of a protruding face. In another embodiment, the target object 3 can also be bonded, screwed, riveted or welded onto the free end of the target object section 8, or joined in some other way.

In a multi-component design of the pad-mounting bracket 7′ and target object 3, there is an advantage in that the material of the target object 3 can be matched better to sensor parameters since the pad-mounting bracket 7′ does not have to have all the functional properties of the target object 3.

The pad-mounting bracket 7′ can also be attached in a positively locking fashion to the brake caliper 10 via a centering device, for example faces and/or pins/bolts, provided in addition to the fastening.

The receptacle pocket 19 can be embodied such that it permits the pad-mounting bracket 7′ to be guided so that it cannot carry out any movements in the transverse direction with respect to the pickup longitudinal axis 22 when braking operations occur.

In FIG. 2, the housing 21 of the application force sensor 2 is provided with an end-side clip. The housing 21 can, for example, be inserted here into a receptacle provided on the caliper head 14 and then be secured to the caliper head 14 by use of the clip. Centering is brought about here by the positive engagement between the receptacle and the housing 21. Of course, faces which prevent the housing 21 from rotating in the receptacle are also possible here.

A distance between the end face 23 of the target object 3 and the end face of the application force sensor 2 is provided both in FIG. 2 and in FIG. 3 of between 0 and 10 mm, preferably between 0.5 and 6.5 mm, as described with respect to FIG. 1. Of course, other distance dimensions are also possible, which may be dependent, for example, on the type and sensitivity of the application force sensor 2.

The invention is not restricted to the exemplary embodiments described above. It is, for example, contemplated for the target object 3 to have a convex design at its end face 23 in order to at least partially compensate for possible pivoting movements of the pad-mounting bracket 7′ and/or of the measuring object 7. The pad-mounting bracket 7′ can be embodied, for example, as a punched/bent part. The target object 3 can also be embodied as at least one end face on the measuring object 7 or pad-mounting bracket 7′.

### LIST OF REFERENCE SYMBOLS

1 Measuring arrangement
2 Application force sensor
3 Target object
4 Evaluation unit
5 Pickup device
6 Booster device
7 Measuring object
7′ Pad-mounting bracket
8 Target object section
9 Measuring point
10 Brake caliper
11 Brake disc
12 Tie rod
13 Caliper back
14 Caliper head
15 Brake pad
16 Pad mounting spring
17 Mounting opening
18 Attachment section
19 Accommodation pocket
20 Attachment element
21 Housing
22 Pickup longitudinal axis
23 End face
24 Connecting line
25 Output line
26 Storage device
27 Measuring bracket
28 Clip
S Displacement distance

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A measuring arrangement for measuring an application force of a disc brake, comprising:
first and second components of the disc brake displaceable relative to one another along a displacement distance when an application force is applied;
at least one application force sensor having a housing;
a measuring object formed by one of the first and second components or being permanently connected to one of the first and second components, the measuring object comprising at least one of a metallic end face and a target object having a metallic end face, for contactless interaction with the application force sensor; and
an evaluation unit operatively coupled with the application force sensor,
wherein the application force sensor is an eddy current sensor that senses displacement along the displacement distance,
wherein the evaluation unit is operatively configured to convert the sensed displacement into a measurement variable as a measure of the application force, and
wherein the application force sensor and the measuring object are attachable to the disc brake in a removable manner.

2. The measuring arrangement according to claim 1, wherein the application force sensor and the measuring object are attachable to the disc brake in at least one of a centering attachment and a positively locking attachment.

3. The measuring arrangement according to claim 1, wherein the application force sensor is permanently connected to one of the first and second components and is arranged at a distance from the metallic end face of the measuring object along the displacement distance; and
wherein one of the first and second components is a caliper back of a brake caliper of the disc brake and another of the first and second components is a caliper head of the brake caliper.

4. The measuring arrangement according to claim 1, wherein the application force sensor comprises a pickup device having a coil and a booster device arranged in the housing.

5. The measuring arrangement according to claim 4, wherein the housing is a hermetically sealed housing.

6. The measuring arrangement according to claim 4, wherein the application force sensor is oriented with the coil of the pickup device on a pickup longitudinal axis at a right angle to the metallic end face of the measuring object.

7. The measuring arrangement according to claim 1, wherein the housing of the application force sensor is removably mountable on one of the first and second components of the disc brake in a positively locking manner with a centering device.

8. The measuring arrangement according to claim 1, wherein the application force sensor has a measuring range larger, by an amount equal to installation tolerances and thermally induced length changes, than a maximum relative displacement of the first and second components that occurs due to the application force.

9. The measuring arrangement according to claim 1, wherein the application force sensor is arranged at a distance from the metallic end face of the measuring object of between 0 mm and 10 mm.

10. The measuring arrangement according to claim 9, wherein the distance is between 0.5 mm and 6.5 mm.

11. The measuring arrangement according to claim 1, wherein the application force sensor outputs a sensor signal calibrateable to a material of at least one of the measuring object, the target object, the surroundings of the measuring object or the target object, and a geometry of the measuring object or the target object.

12. The measuring arrangement according to claim 1, wherein the application force sensor outputs a sensor signal calibrateable to a material of the housing.

13. The measuring arrangement according to claim 1, wherein the application force sensor outputs a temperature-compensated sensor signal.

14. The measuring arrangement according to claim 1, wherein the application force sensor is operatively configured for zero point alignment of a sensor signal that is to be output.

15. The measuring arrangement according to claim 1, wherein the application force sensor outputs a linearized sensor signal.

16. The measuring arrangement according to claim 15, wherein linearization of the output of the application force sensor is carried out with respect to at least one of a change in position of the measuring object, a change in position of the target object, and the application force.

17. The measuring arrangement according to claim 4, wherein the pickup device, the booster device, and the evaluation unit are arranged in the housing.

18. The measuring arrangement according to claim 4, wherein the coil of the pickup device is arranged in the housing, and wherein further switching units of the pickup device, the booster device and the evaluation unit are arranged separately therefrom.

19. The measuring arrangement according to claim 18, further comprising a wear sensor unit of the disc brake, wherein the further switching units are arranged in the wear sensor unit.

20. The measuring arrangement according to claim 4, wherein the pickup device and the booster device are arranged in the housing, and further wherein the evaluation unit is arranged in a wear sensor unit of the disc brake.

21. The measuring arrangement according to claim 1, wherein the application force sensor is provided with a line connectable permanently or via plug-type connectors.

22. The measuring arrangement according to claim 21, wherein the line is embodied to form a wear sensor unit and a common cable leading to an electronic braking system (EBS).

23. The measuring arrangement according to claim 21, wherein the line is combined with a cable of a wear sensor unit.

24. The measuring arrangement according to claim 1, wherein the housing is attached at least one of directly and via a clip to one of the first and second components.

25. The measuring arrangement according to claim 1, wherein a pad-mounting bracket forms the measuring object, the pad-mounting bracket being fixedly connected to one of the first and second components of the disc brake.

26. The measuring arrangement according to claim 25, wherein the pad-mounting bracket comprises the metallic end face or the target object having the metallic end face.

27. The measuring arrangement according to claim 26, wherein the target object is attached to the pad-mounting bracket directly or via a mounting element.

28. The measuring arrangement according to claim 27, wherein the target object is attached in a removable manner.

29. The measuring arrangement according to claim 26, wherein the target object and pad-mounting bracket are in one piece.

30. The measuring arrangement according to claim 25, wherein the pad-mounting bracket is attachable with a centering device to said one of the first and second components.

31. The measuring arrangement according to claim 25, wherein the pad-mounting bracket is guided in a displaceable manner via a guide device on the other of the first and second components in a direction of the displacement distance.

32. The measuring arrangement according to claim 1, wherein the metallic end face has a convex design.

33. A disc brake for selectively applying brake pads against a brake disc, the disc brake comprising:
a brake caliper operatively configured to straddle the brake disc, the brake caliper comprising a caliper head arranged on one side of the brake disc and a caliper back arranged on another side of the brake disc;
a pad-mounting bracket operatively arranged to secure radially the brake pads arranged in the caliper;
an application force sensor having a housing;
an evaluation unit operatively coupled with the application force sensor;
wherein the brake caliper and pad-mounting bracket are displaceable relative to one another along a displacement distance when an application force is applied;
wherein one of the pad-mounting bracket and the brake caliper include a measuring object having a metallic end face for contactless interaction with the application force sensor;
wherein the application force sensor is an eddy current sensor for sensing displacement along the displacement distance;
wherein the evaluation unit converts the sensed displacement into a measurement variable as a measure of the application force; and
wherein the application force sensor and the measuring object are removable components.

34. An application force sensor for a measuring arrangement according to claim 1.

35. A pad-mounting bracket for the measuring arrangement according to claim 1, the pad-mounting bracket forming one of the first and second components of the disc brake.
